(19) United States
(12) Patent Application Publication
(10) Pub. No.: US 2003/0063740 A1
(43) Pub. Date: Apr. 3, 2003

(54) Method of providing multilevel quality signals

(76) Inventor: Richard B. Sagar, Santa Clara, CA (US)

Correspondence Address: Corporate Patent Counsel, Philips Electronics North, America Corporation, 580 White Plains Road, Tarrytown, NY, 10591, US

(21) Appl. No.: 09/931,952

(22) Filed: Aug. 20, 2001

(51) Int. Cl. H04L 9/00

(52) U.S. Cl. 380/28

(57) ABSTRACT

A method of providing a multilevel quality signal comprises separating out a component of the signal, encrypting the separated out component and then recombining the signal components. The resulting signal has two quality levels, a high quality level, for example CD quality, and a lower but still acceptable level, over a single channel. A decrypting key can be provided to selected receivers, i.e., payee receivers, for reception of the high quality signal.

### BACKGROUND OF THE INVENTION

This invention relates to the provision of signals broadcast in various ways, in which signals are encoded or encrypted for control of access.

Broadcast signals or content as for broadcasting movies, sports, music, etc. by radio, cable TV, or satellite are usually sent “Free to air” which is freely available to any receiver, or “subscription”, which requires a “payment to view” by a receiver.

With such schemes, when restricted access is required, encryption of the entire signal occurs. Thus the only receivers which can access the signal are those who have “paid” for access. This can be done by providing a key—either at the sending end or the receiving end. Without the key the signal is completely unavailable to a receiver.

A typical example is in “Pay TV” where it is arranged that a receiver can pay a subscription fee and is then provided with the facility to decrypt the signal.

In all such schemes either no useable signal is received, or a full quality signal is received.

### SUMMARY OF THE PRESENT INVENTION

The present invention provides a method for broadcasting a signal at two quality levels simultaneously over a single channel. The signal received by a receiver in one situation will be of low quality but still reasonably acceptable. When provided with a decryption key a high quality signal is received. Thus the “free to air” signal version will be at a low quality level, whereas the “Pay per View” or “Subscription” version will be of a higher quality.

The two versions of the content are sent in a single program channel, and thus the broadcaster does not need two channels to send the two versions.

Broadly, the invention is to a method of providing multilevel quality signals, in which a component of the signal is divided out, encrypted and then recombined into a signal having both a high quality and a lower quality level. Typically, in a digital signal having a predetermined sample rate each sample having predetermined bits, a lower bit portion of a sample can be separated out, encrypted and then combined with the rest of the signal. Alternatively separation of a portion of the sample rate could be encrypted. A key is provided for decryption by a receiver.

### DESCRIPTION OF THE PREFERRED EMBODIMENT

In digital encoding the quality of the translation from analogue to digital is largely determined by two factors:

the number of bits in the analogue-digital conversion; and

the sample-rate of the encoding.

As an example, CD audio is sampled at 44100 samples/second and each sample is 16 bits. Lower sample rates and/or numbers of bits result in lower quality content.

In the present invention, a signal such as digital audio, would be sampled at the higher rate, then a component separated out (for example the lower 3 bits of the sample). This smaller component would then be encrypted. The two components can then be sent together in a multiplex to the interested party. Without the appropriate decryption key to decrypt the 3 bit portion of the content, the receiver would be forced to provide only a 13 bit audio stream, which would be acceptable, but noticeably less than CD quality.

For a suitable fee, the receiver would be given the key to decrypt the 3 bit portion of the content, allowing the receiver to reconstitute the full CD quality context.

The key could be provided to the end user in various ways. For example, the key could be provided either on a “smart card”, which would be purchased from any convenient location, or via mail order. Alternatively, by using equipment with the capability to contact a central server (via Internet or phone network and modem for example) the receiver could transfer payment details to the broadcaster and in return the decryption key could be provided to the receiver.

An alternative, requiring more sophisticated equipment, would allow for separation of a portion of the sample rate, providing another way of reducing the quality of the free to air component of the signal content.

The invention can be used on traditional broadcast or Internet streamed content.

The invention enables the normal broadcasting of a signal, at two quality levels simultaneously over a single channel.

It can be such that at some times a signal can be broadcast at a single level—normally a high level of quality for free to air use, while at other times the signal would be broadcast at two quality levels. Thus, in effect some programs would be free while at certain times some programs could only be received at a high quality on payment of a fee. With the latter arrangement, a lower quality signal would still be available to a user without payment of a fee.

In another embodiment the signal comprises video image data. Typical video image data includes red green and blue signal contents to provide full colour. If the colour signals are limited to, for example, three bits each, a suitable video image appears for review but the image is clearly not of a quality that compares to television or DVD quality. Thus, for example, a 24 bit colour image would provide 9 bits and the remaining 15 bits of the red, green, and blue signals is encrypted for later decoding. This provides images which are, most often, discernible but of very low quality. Of course, more bits can be included in the low-quality signal when so desired.

Typically, since the encoded data was originally within the image, a one to one encoding scheme allows for an image of the same quality over all—once the additional bits are decoded—without requiring any further space.

Though the description refers to bits, it is also possible to encode the data in other forms and to therefore divide it according to its encoding.

Numerous other embodiments may be envisaged without departing from the spirit or scope of the invention.

What is claimed is:

1. A method of providing a multilevel quality signal having multiple components, comprising the steps of:
providing a first component of a first signal;
providing a second component of the first signal;
encoding the first component to provide an encoded component; and
combining the second component and the encoded component to provide the multilevel quality signal having a lower quality level component and having therein the encoded component for use in enhancing the quality level of the lower quality level component.

2. A method of providing a multilevel quality signal according to claim 1 wherein the step of encoding the first component includes the step of encrypting the first component.

3. A method as claimed in claim 2 including the step of providing a key for decrypting the encrypted component.

4. A method of providing a multilevel quality signal according to claim 2 wherein access to the first component requires a decryption operation on the encrypted first component.

5. A method of providing a multilevel quality signal according to claim 1, wherein the steps of providing a first component of the first signal and providing a second component of the first signal include a step of separating the first component from the second component of the first signal.

6. A method as claimed in claim 1, comprising the steps of:
sampling the first signal at a predetermined sample rate to generate a plurality of samples, each sample having a predetermined number of bits; and,
separating out a subset of the bits of each sample to provide the first component.

7. A method as claimed in claim 6, wherein the subset is a lower order bit portion of the samples.

8. A method as claimed in claim 5, wherein the first signal is sampled at a sample rate to generate a plurality of samples, each sample having a number of bits and wherein the step of separating the first component from the second component of the first signal comprises the step of separating some samples from the first signal at known intervals.

9. A method as claimed in claim 5 wherein the step of separating the first component from the second component of the first signal depends on predetermined periods of broadcasting of the first signal.

10. A method as claimed in claim 1, comprising the step of providing a high quality level signal for a period of time and simultaneously providing for another period of time the lower quality level component with the encoded first component for use in enhancing the lower quality level of the lower quality component.

11. A method of providing a multilevel quality signal according to claim 1 wherein the multilevel quality signal includes more than two components each further component being encoded and for use in further enhancing the quality level of the lower quality component.

12. A device for enabling provision of a multilevel quality signal having multiple components comprising:
a means for separating a first component from multiple components of a first signal;
a processor for encrypting the first component and for combining the encrypted first component with at least another component of the first signal to provide the multilevel quality signal having a high quality level and a lower quality level, wherein access to the high quality level of the multilevel quality signal requires a decryption operation on the encrypted first component.

13. A device for enabling provision of a multilevel quality signal according to claim 12 further comprising a sampling means for sampling the first signal at a predetermined sample rate.

14. A device for enabling provision of a multilevel quality signal according to claim 13, wherein the means for separating a first component from multiple components of a first signal includes means for separating a lower order bit portion from a digitised version of the first signal to provide the first component.

15. A device for enabling provision of a multilevel quality signal according to claim 12, wherein the processor includes means for formatting the multilevel quality signal for broadcasting thereof in accordance with predetermined broadcasting parameters.

16. A storage medium having instructions stored therein for generating a multilevel quality signal from a first signal by the steps of:
separating the first signal into at least two components;
encrypting one of the at least two components; and
combining the encrypted component with another component of the at least two components of the first signal to provide the multilevel quality signal having a high quality level and a lower quality level, wherein access to the high quality level of the multilevel quality signal requires a decryption operation on the encrypted component

17. A storage medium according to claim 16 wherein the step of separating the first signal into at least two components comprises the step of sampling the first signal at a sample rate, each sample having a number of bits and separating the low order bits from the sampled signal to provide a low order bit component and a high order bit component forming the at least two components.

18. A storage medium according to claim 16 wherein the step of separating the first signal into at least two components comprises the step of sampling the first signal at a sample rate, each sample having a number of bits and separating the sampled signal into a plurality of samples forming a first component and a plurality of other samples forming a second other component, the components forming the at least two components.

19. A multilevel quality signal comprising:
a first component for providing a low quality output signal;
a second encoded component for use in enhancing the quality of the low quality output signal,
wherein the first component and the second component together form the multilevel quality signal and wherein decoding of the second encoded component allows for enhancement of the low quality output signal to provide a higher quality output signal therefrom.

20. A multilevel quality signal according to claim 19 wherein the second encoded component is encoded for other than enhancing the quality of the low quality output signal in encoded form.

21. A multilevel quality signal according to claim 20 wherein the multilevel quality signal is compatible with standards for providing at least one of audio and video data without separating the encoded component therefrom.

22. A multilevel quality signal according to claim 21 wherein the second encoded component is encrypted.
